(19) United States
(12) Patent Application Publication
(10) Pub. No.: US 2008/0041684 A1
(43) Pub. Date: Feb. 21, 2008

(54) Torque Converter

(75) Inventors: Mitsuru Kuwahata, Katano-shi (JP); Hiroyuki Sano, Hirakata-shi (JP); Satoru Matsuda, Hirakata-shi (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 11/667,790

(22) PCT Filed: Oct. 28, 2005
(86) PCT No.: PCT/JP05/19885

§ 371 Date: May 15, 2007

(30) Foreign Application Priority Data
Nov. 24, 2004 (JP) 2004-338792

(51) Int. Cl. F16H 45/02; F16H 41/24

(52) U.S. Cl. 192/3.29

(57) ABSTRACT

A torque converter (1) in which an outer periphery end of a torsion spring (52) of a lock-up device (4) is positioned radially inward relative to an inner periphery end of a working fluid chamber, which includes a simplified structure of the lock-up device. According to the torque converter (1), the outer periphery of the torsion spring (52) is positioned radially inward relative to the inner periphery of the working fluid chamber (3). The lock-up device (4) includes a piston (41) that is connectable to a front cover (21), the torsion spring (52), a drive member (50) that is fixed to the piston and adapted to drive the torsion spring (52), and a driven member (51) that is fixed to a turbine shell (20) and driven by the torsion spring (52).

### TECHNICAL FIELD

The present invention relates to a torque converter. More particularly, the present invention pertains to a torque converter, which includes a lock-up device.

### BACKGROUND ART

Generally, a torque converter enables smooth acceleration and deceleration of a vehicle by using fluid to transmit power. However, fluid slippage causes loss of energy, which deteriorates fuel economy.

In order to overcome the foregoing drawback, a known torque converter includes a lock-up device mechanically coupling a front cover provided at an input side and a turbine provided at an output side. The lock-up device is arranged in a space between the front cover and the turbine. The lock-up device includes a disc-shaped piston that is pushed towards the front cover, a driven plate that is provided at the back of the turbine, and a torsion spring elastically connecting the piston and the driven plate in a rotational direction. An annular friction member is adhered to the piston at a position facing a plane friction surface of the front cover.

According to the known lock-up device, the piston is controlled to operate in response to a change in hydraulic pressure in a fluid chamber. Particularly, in a state where the lock-up device is disengaged, working fluid is supplied from a hydraulic pressure circuit that is externally provided to the space between the piston and the front cover. The working fluid flows in the space between the front cover and the piston in a radially outward direction, and flows into a torque converter main body at an outer periphery portion. When the lock-up device is engaged, the working fluid in the space between the front cover and the piston is drained from an inner periphery side, and the piston moves towards the front cover because of the hydraulic pressure difference, accordingly. Consequently, the friction member provided on the piston is pushed onto the friction surface of the front cover. Thus, a torque is transmitted from the front cover to the turbine via the lock-up device.

In the meantime, technological advances in the performance of a damper mechanism is desired in response to use of the lock-up device at a low speed state of a vehicle and in response to a use of the torque converter in higher torque. Further, in recent years, a torque converter in which torque is transmitted by the fluid only at vehicle start up, and in which the lock-up device is engaged, for example, when vehicle speed is equal to or faster than 20 km/h, has been known. Accordingly, with the construction in which a lock-up region is increased, performance improvement of a torsion spring is required so that torsional vibration can be adequately absorbed or damped in response to the fluctuation of a torque from an engine. Particularly, the improvement in vibration absorbing/damping performance relative to the torsional vibration by increasing the length of radius of the torsion spring is required.

However, since the torsion spring is arranged between the front cover and the turbine in an axial direction, upsizing the torsion spring results in upsizing the overall torque converter.

In order to overcome the aforementioned drawback, a known torque converter achieves an increase in dimension of the torsion spring by arranging the torsion spring of the lock-up device at an inner periphery side in a working fluid chamber (e.g., See Patent Document 1).

Patent Document 1: EUROPEAN PATENT APPLICATION 0070662A1

### DISCLOSURE OF INVENTION

Notwithstanding, the known lock-up device for the torque converter includes a pair of input side plate members that are fixed to a piston, an output side plate member arranged between the input side plate members in an axial direction and fixed to a turbine hub, and a torsion spring connecting the input side plate members and the output side plate member in the rotational direction. The output side plate member is fixed to the turbine hub together with a turbine shell with rivets.

With the construction of the known torque converter, a structure is complex and the number of parts is increased, which increases manufacturing cost.

It is an object of the present invention to simplify the structure of the lock-up device in a torque converter in which an outer periphery end of the torsion spring of the lock-up device is positioned radially inward relative to an inner periphery end of the working fluid chamber.

### Means for Solving the Problems

A torque converter according to a first aspect of the present invention includes a front cover; an impeller, a turbine, a stator, and a lock-up device. The impeller is coupled to the front cover to form a fluid chamber. The turbine is arranged to face the impeller in the fluid chamber and includes a turbine shell, a turbine blade fixed to an impeller side surface of the turbine shell, and a turbine hub that is fixed to an inner periphery portion of the turbine shell. The stator is arranged between an inner periphery portion of the impeller and the inner periphery portion of the turbine, and forms a working fluid chamber together with the impeller and the turbine. A lock-up device is arranged between the front cover and the turbine to couple mechanically the front cover and the turbine. The lock-up device includes a torsion spring that absorbs and damps torsional vibrations. An outer periphery end of the torsion spring is positioned radially inward relative to an inner periphery end of the working fluid chamber. The lock-up device includes a piston that is configured to be connected to a front cover, a torsion spring, a drive member that is fixed to the piston and that drives the torsion spring, and a driven member that is fixed to the turbine shell and driven by the torsion spring.

With this torque converter, the driven member of the lock-up device is fixed to the turbine shell. This construction simplifies the structure of the lock-up device.

A torque converter according to a second aspect of the present invention is the torque converter of the first aspect, wherein the driven member is fixed to a fixing portion of the turbine shell, which is positioned radially inward relative to a portion of the turbine shell to which the turbine blade is fixed.

With this torque converter, since the driven member is fixed to the inner periphery side portion of the turbine shell, a structure of the lock-up device is simplified.

A torque converter according to a third aspect of the present invention is the torque converter of the second aspect, wherein the stator includes an annular stator carrier and a stator blade that is provided on an outer periphery surface of the stator carrier. The stator carrier includes a recess portion formed at a surface close to the torsion spring corresponding to the position of the torsion spring.

With this torque converter, since the stator carrier includes the recess portion at the position corresponding to the torsion spring, the axial dimension of an inner periphery portion of the torque converter can be adequately shorten.

A torque converter according to a fourth aspect of the present invention is the torque converter of the third aspect, wherein a fixing portion of the turbine shell is configured to have a shape along the recess portion and arranged close to the recess portion.

With this torque converter, since the fixing portion of the turbine shell is configured to have a recess at a surface facing the torsion spring, the axial dimension of the inner periphery portion of the torque converter can be adequately short.

A torque converter according to a fifth aspect of the present invention is the torque converter of the fourth aspect, wherein the fixing portion of the turbine shell is positioned close to a center position of the impeller and the turbine in the axial direction.

With this torque converter, since the fixing portion of the turbine shell is positioned adequately close to the transmission in the axial direction, the axial dimension of the inner periphery portion of the torque converter can be adequately short.

A torque converter according to a sixth aspect of the present invention is the torque converter of the fifth aspect, wherein the fixing portion of the turbine shell is positioned closer to the impeller relative to the center position of the impeller and the turbine in an axial direction.

With this torque converter, since the fixing portion of the turbine shell is positioned adequately close to the transmission in the axial direction, the axial dimension of the inner periphery portion of the torque converter can be adequately short.

A torque converter according to a seventh aspect of the present invention is the torque converter of any of the second through sixth aspects, wherein the fixing portion of the turbine shell includes a plane surface that is vertical to a rotational axis.

With this torque converter, since the fixing portion includes the plane surface, the driven member can be readily and securely fixed.

A torque converter according to an eighth aspect of the present invention is the torque converter of any of the first through seventh aspects, wherein the driven member is annularly arranged corresponding to the position of the torsion spring.

With this torque converter, since the driven member is positioned corresponding to the position of the torsion spring, a damper mechanism is downsized in a radial direction.

A torque converter according to a ninth aspect of the present invention is the torque converter of any of the first through eighth aspects, wherein the driven member includes a plurality of claws that extends towards the piston and is in contact with ends of the torsion spring in a rotational direction.

With this torque converter, the driven member is simply constructed including the claws.

A torque converter according to a tenth aspect of the present invention is the torque converter of any of the first through ninth aspects, wherein an end of the torsion spring closer to the engine in an axial direction is positioned closer to the transmission in the axial direction compared to a most engine side end of the turbine shell.

With this torque converter, since the torsion spring is arranged adequately close to the transmission in the axial direction, the axial dimension of the inner periphery portion of the torque converter can be adequately short.

### EFFECTS OF THE INVENTION

According to a torque converter of the present invention, since a driven member of a lock-up device is fixed to a turbine shell, a structure of the lock-up device is simplified.

### BRIEF DESCRIPTION OF DRAWINGS

FIG. 1 is a longitudinal cross-sectional view of a torque converter according to an embodiment of the present invention.

FIG. 2 is a partial plane view of a lock-up device.

### EXPLANATIONS FOR REFERENCE NUMBER

1 torque converter
4 lock-up device
11 turbine
20 turbine shell
20a inner periphery portion (fixing portion)
27 stator carrier
41 piston
42 damper mechanism
50 drive member
51 driven member
52 torsion spring

### MODE FOR CARRYING OUT THE INVENTION

### (1) Structure

An embodiment of the present invention will be explained with reference to the illustrations of the drawing figures as follows.

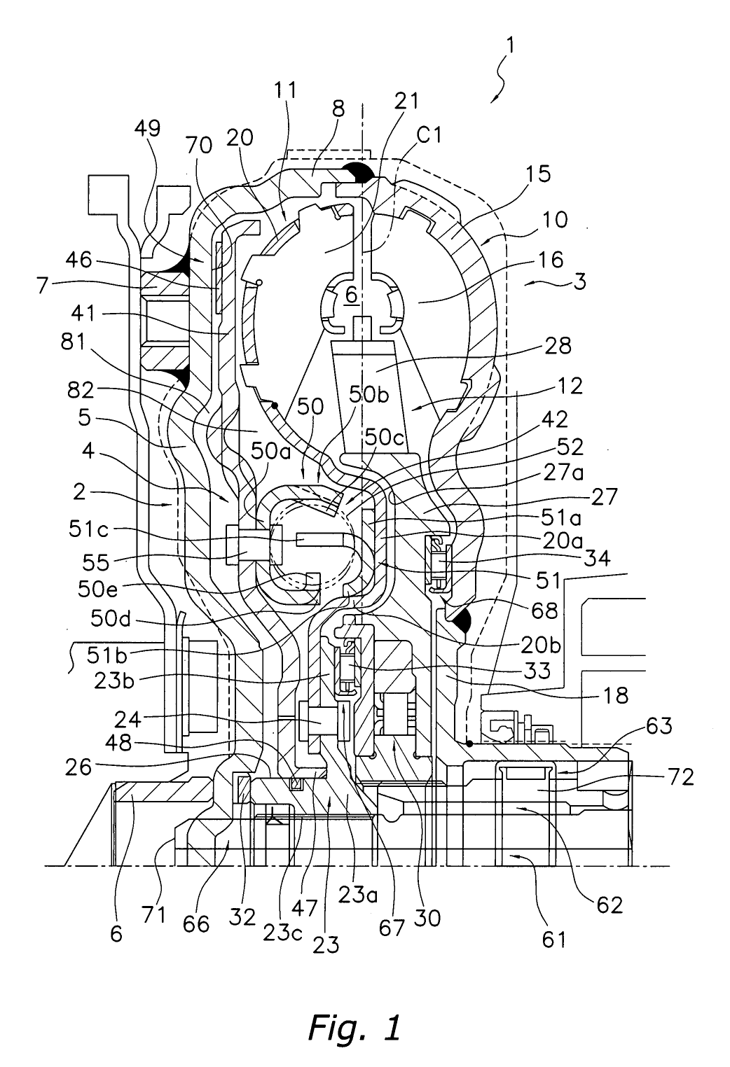

As shown in FIG. 1, a torque converter 1 includes a front cover 2, a torus shaped working fluid chamber 3 including three kinds of vanes (i.e., an impeller 10, a turbine 11, and a stator 12), which are arranged coaxially to the front cover 2, and a lock-up device 4 arranged in a space between the front cover 2 and the turbine 11 in an axial direction. Outer peripheral portions of the front cover 2 and an impeller shell 15 of the impeller 10 are fixed by welding. The front cover 2 and the impeller shell 15 of the impeller 10 form a fluid chamber that is filled with working fluid.

The front cover 2 receives torque inputted from a crankshaft of an engine. The front cover 2 includes a disc-shaped main body 5. A center boss 6 is fixed at the center of the main body 5. A plurality of nuts 7 is fixed to a surface of the main body 5 at an engine side and at an outer periphery portion thereof. An outer periphery cylindrical portion 8 that extends towards a transmission in an axial direction is integrally formed with the outer periphery portion of the main body 5.

An annular and plane friction surface 70 is formed on an inner side and at the outer periphery portion of the main body 5 of the front cover 2. The friction surface 70 faces the transmission in the axial direction.

The working fluid chamber 3 is positioned in the fluid chamber closer to the transmission in the axial direction. Thus, the fluid chamber is separated into the working fluid chamber 3 and a space formed between the main body 5 of the front cover 2 and the turbine 11.

The impeller 10 includes the impeller shell 15, a plurality of impeller blades 16 fixed to an inner surface of the impeller shell 15, and an impeller hub 18 fixed to an inner periphery end of the impeller shell 15. The impeller blades 16 are configured to be significantly shorter in a radial direction compared to a known impeller blade, and fixed to an inside of an outer periphery portion of the impeller shell 15.

The turbine 11 is arranged facing the impeller 10 in the fluid chamber. The turbine 11 includes a turbine shell 20, a plurality of turbine blades 21 fixed to the turbine shell 20, and a turbine hub 23 fixed to an inner periphery end of the turbine shell 20. The turbine blade 21 is configured to be significantly shorter in a radial direction compared to a known turbine blade, and is fixed to an inside of an outer periphery portion of the turbine shell 20.

The turbine hub 23 includes a cylindrical boss 23a and a flange 23b extended outward in a radial direction from the boss 23a. The flange 23b is fixed to an inner periphery portion of the turbine shell 20 by a plurality of rivets 24. Further, a spline 23c is formed on an inner peripheral surface of the boss 23a. The spline 23c is engaged with a main driveshaft 71 that extends from the transmission side. Accordingly, a torque transmitted from the turbine hub 23 is outputted to the main driveshaft 71.

The stator 12 is arranged between an inner periphery portion of the impeller 10 and an inner periphery portion of the turbine 11. The stator 12 redirects the working fluid returning from the turbine 11 to the impeller 10 to achieve torque amplification by the torque converter 1. By the torque amplification of the torque converter 1, exceptional accelerating performance can be achieved when the vehicle starts. The stator 12 includes a stator carrier 27 and a plurality of stator blades 28 that is provided on an outer periphery surface of the stator carrier 27.

The stator carrier 27 is supported by a stator shaft 72 via a one-way clutch 30. The stator shaft 72 is a cylindrical member arranged around the main driveshaft 71. The stator carrier 27 extends longer in a radial direction compared to a known stator carrier, and a throughout surface 27a at an engine side in an axial direction is recessed. Particularly, a middle portion in the radial direction of the surface 27a of the stator carrier 27, which faces the engine in the axial direction, is positioned closer to the transmission in the axial direction relative to an outer periphery portion of an inlet side surface of the stator blade 28 and relative to an inner periphery portion of the stator blade 28. Thus, naturally, the surface 27a is positioned closer to the transmission side in the axial direction relative to a center position C1 in an axial direction of the working fluid chamber 3.

Further, an inner periphery portion 20a of the turbine shell 20 (i.e., a portion to which the turbine blade 21 is not fixed) is curved in an axial direction along a line of the stator carrier 27, and a middle portion in a radial direction of the inner periphery portion 20a is positioned closer to the transmission in the axial direction relative to the center position C1 in the axial direction of the working fluid chamber 3. Since the inner periphery portion 20a of the turbine shell 20 is approximate to the center position C1 of the impeller 10 and the turbine 11 in the axial direction and is adequately close to the transmission side in the axial direction, the axial dimension of the inner periphery portion of the torque converter 1 can be made adequately shorter. More particularly, the inner periphery portion 20a of the turbine shell 20 is positioned closer to the impeller 10 relative to the center position C1 of the impeller 10 and the turbine 11 in the axial direction and is positioned adequately close to the transmission side in the axial direction, the axial dimension of the inner periphery portion of the torque converter 1 can be made adequately shorter. As explained above, by forming the recess portion recessed facing the engine in the axial direction by curving the stator carrier 27 and by curving the turbine shell 20 to protrude towards the transmission side in the axial direction, a space to accommodate a damper mechanism 42 is ensured at the inner periphery portion in the working fluid chamber 3, particularly, at the inner periphery of a portion corresponding to the turbine 11.

A first washer 32 is arranged between the main body 5 of the front cover 2 and the turbine hub 23 in an axial direction. A plurality of grooves extending in a radial direction is formed on the first washer 32, and the grooves allow the working fluid to flow on both sides of the first washer 32 in the radial direction. A first port 66 through which the working fluid flows in a radial direction is formed between an internal periphery portion of the front cover 2 and the turbine hub 23 in the axial direction. The first port 66 establishes communication between an oil passage 61 formed in the main driveshaft 71 and a front chamber 81 provided between the front cover 2 and a piston 41.

A second thrust bearing 33 is provided between the turbine hub 23 and the one-way clutch 30. Working fluid flows at the both sides of the second thrust bearing 33 in a radial direction. A second port 67, which allows the working fluid to communicate on both sides thereof in a radial direction, is formed between the turbine hub 23 and an inner periphery portion of the stator 12 (i.e., particularly, between the turbine hub 23 and the one-way clutch 30). Namely, the second port 67 establishes communication between the working fluid chamber 3 and an oil passage 62 formed between the main driveshaft 71 and the stator shaft 72.

A third thrust bearing 34 is provided between the stator carrier 27 and an inner periphery portion of the impeller shell 15 in an axial direction. Working fluid flows on both sides of the third thrust bearing 34 in a radial direction. A third port 68, which allows the working fluid to communicate on both sides thereof in a radial direction, is formed between the stator 12 (i.e., particularly, the stator carrier 27) and the impeller 10 in an axial direction. In other words, the third port 68 establishes communication between the working fluid chamber 3 and an oil passage 63 formed between the stator shaft 72 and the impeller hub 18.

Each of the oil passages 61-63 is connected to hydraulic circuits respectively so that the working fluid can be independently supplied to and discharged from the first through third ports 66-68.

The lock-up device 4 is arranged in the annular space formed between the main body 5 of the front cover 2 and the turbine 11 in the axial direction, and mechanically connects and disconnects the front cover 2 and the turbine 11 in response to changes in the hydraulic pressure in the space. The lock-up device 4 includes a piston function that operates in accordance with changes in the hydraulic pressure in the space, and a damper function that absorbs and damps the torsional vibration in a rotational direction. The lock-up device 4 includes the piston 41 and the damper mechanism 42. The piston 41 is a disc-shaped member positioned in the space close to the main body 5 of the front cover 2. The piston 41 divides the space into the front chamber 81 at the front cover 2 side and a rear chamber 82 at the turbine 11 side. An outer periphery portion of the piston 41 serves as a frictional connecting portion 49 arranged on the transmission side in an axial direction relative to the friction surface 70 of the front cover 2. A frictional connecting portion 49 is an annular and plane plate portion on which an annular friction facing 46 is attached on a side facing the engine in an axial direction.

An inner periphery cylindrical portion 47 is formed at an inner peripheral end of the piston 41. The inner periphery cylindrical portion 47 extends from the inner peripheral end of the piston 41 towards the transmission side in an axial direction. An inner periphery surface of the inner periphery cylindrical portion 47 is supported by an outer periphery surface 26 of the turbine hub 23 so as to move in an axial direction and a rotational direction. A side of the inner periphery cylindrical portion 47 closer to the transmission in an axial direction is configured to contact a flange 23b of the turbine hub 23. Accordingly, the movement of the piston 41 towards the transmission in the axial direction is restricted. An annular groove is formed on the outer periphery surface 26 and a seal ring 48 is provided therein. The seal ring 48 is in contact with the inner periphery surface of the inner periphery cylindrical portion 47. The both sides of the inner periphery portion of the piston 41 in the axial direction are sealed by the seal ring 48.

The damper mechanism 42 transmits a torque from the piston 41 to the turbine hub 23, and absorbs and damps the torsional vibration. The damper mechanism 42 is arranged between the inner periphery portion of the turbine shell 20 and a middle portion of the piston 41 in a radial direction. Particularly, the damper mechanism 42 is positioned in an annular space facing the recess portion of the inner periphery portion 20a of the turbine shell 20.

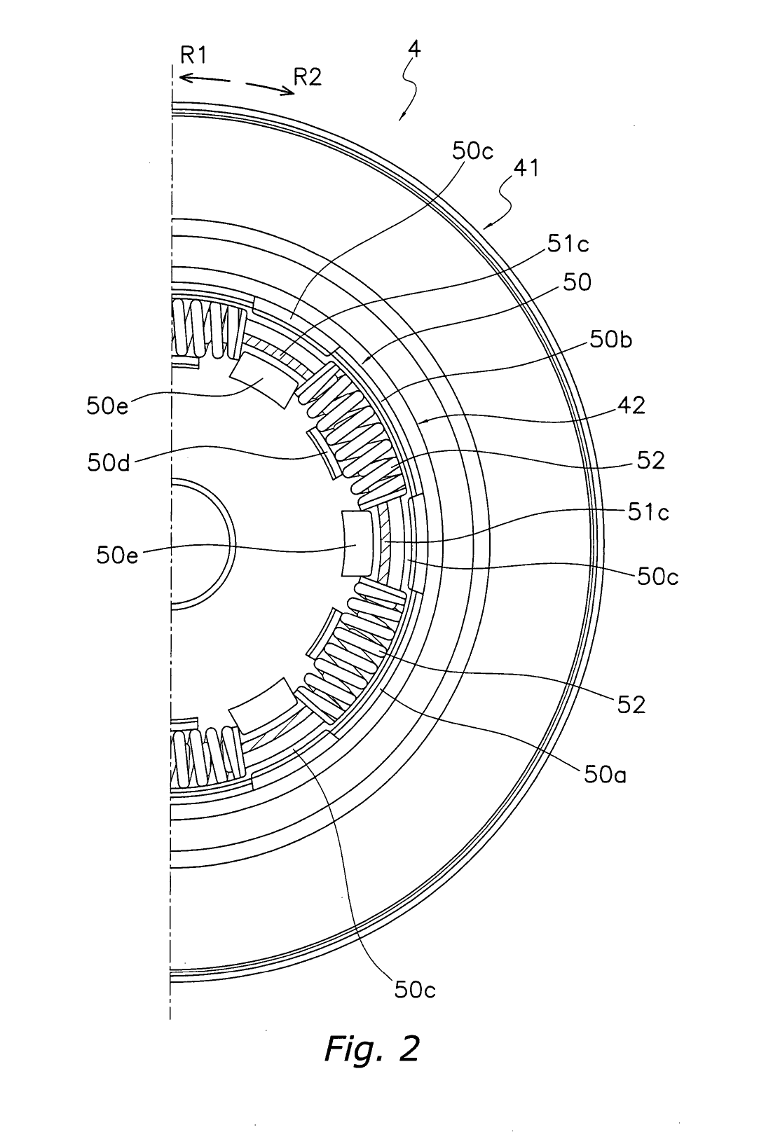

The damper mechanism 42 includes a drive member 50, a driven member 51, and a torsion spring 52. In FIG. 2, arrow R1 shows a rotational direction for driving and arrow R2 shows a direction for coasting.

The drive member 50 is for inputting a torque to the torsion spring 52 and further functions to retain the torsion spring 52 on the piston 41. The drive member 50 is an annularly extended plate member and is fixed to a surface of the piston 41 at the transmission side in the axial direction. The drive member 50 is arranged facing the recess portion of the inner periphery portion 20a of the turbine shell 20 in the axial direction. Particularly, the drive member 50 includes a disc shaped portion 50a that is in contact with the piston 41 and an outer periphery cylindrical portion 50b that extends from an outer periphery end of the disc shaped portion 50a towards the transmission side in the axial direction. The disc shaped portion 50a is fixed to the piston 41 by a plurality of rivets 55 that is arranged on a plurality of positions in a circumferential direction.

The torsion spring 52 is an elastic member that absorbs the torsional vibration, and is, for example, made from a coil spring. The plurality of torsion springs 52 is arranged in a circumferential direction. The torsion springs 52 are positioned on the transmission side of the disc shaped portion 50a of the drive member 50 and radially inward of the outer periphery of the cylindrical portion 50b. In those circumstances, the torsion springs 52 are arranged between the rivets 55. A tip end of the outer periphery cylindrical portion 50b is slightly bent inward in a radial direction so as to restrict the movement of the torsion spring 52 in an axial direction.

The outer periphery cylindrical portion 50b includes a first support portion 50c that is deformed by draw forming to protrude inward in a radial direction at a position between the torsion springs 52 in a rotating direction. The both ends of the first support portion 50c in a rotational direction are in contact with ends of the torsion spring 52 (i.e., more particularly, in contact with a spring sheet) in a rotational direction.

The drive member 50 includes a second support portion 50e that extends from an inner periphery end of the disc shaped portion 50a towards the transmission side in the axial direction at a position between the torsion springs 52 in a rotating direction. A tip end of the second support portion 50e is bent outwardly in a radial direction. The both ends of the second support portion 50e in the rotational direction are in contact with ends of the torsion spring 52 (i.e., particularly, in contact with the spring sheet) in the rotational direction. Further, the drive member 50 includes a third support portion 50d that extends from an inner periphery end of the disc shaped portion 50a towards the transmission side in the axial direction at a position corresponding to the torsion spring 52. The third support portion 50d restricts the inward movement of the torsion spring 52 in the radial direction.

The driven member 51 is an annular plate member and is fixed to an inner periphery portion of the turbine shell 20. More particularly, the driven member 51 includes an annular portion 51a that is fixed to the recess portion 20a of the turbine shell 20 by brazing or welding (e.g., TIG welding). The annular portion 51a includes a plane that is vertical to a rotational axis and so does the recess portion 20a. The inner periphery portion of the annular portion 51a includes an annular protrusion 51b that extends towards the engine in the axial direction along a line of a cylindrical portion 20b that is formed at the inner peripheral side of the recess portion 20a. Further, the driven member 51 includes engagement claws 51c (i.e., serving as claws) which are formed by curving and lifting an outer periphery portion side of the annular portion 51a to extend towards the engine in the axial direction. The engagement claw 51c extends between the torsion springs 52, 52, and ends of the engagement claw 51c in the rotational direction are in contact with ends of the torsion springs 52 (i.e., particularly, in contact with ends of the spring sheet) in the rotational direction. Since the inner periphery portion 20a of the turbine shell 20 is shaped on a plane, the driven member 51 is readily and securely fixed to the inner periphery portion 20a of the turbine shell 20.

The torsion spring 52 is positioned at an inner periphery side in the working fluid chamber 3. More particularly, an outer periphery end of the torsion spring 52 is positioned radially inward compared to an inner periphery end of the working fluid chamber 3 (i.e., an outer periphery surface of the stator carrier 27). Further, a portion of the torsion spring 52 is in the inner periphery side of the working fluid chamber 3, and a transmission side end of the torsion spring 52 in the axial direction is positioned closer to the center position C1 of the torus in the axial direction relative to a transmission side end of the turbine blade 21 of the turbine 11 in the axial direction. Further, since the driven member 51 is annularly arranged corresponding to the position of the torsion spring 52, the damper mechanism 42 is downsized in a radial direction.

Accordingly, a coil diameter of the torsion spring 52 is significantly increased compared to a known torsion spring without increasing the axial dimension of the torque converter 1 per se. An increase of the coil diameter of the torsion spring 52 can readily improve performance of the torsion spring 52. Consequently, torque transmission by fluid using the torus of the torque converter 1 is applied only when vehicle starts and thereafter, the torque converter 1 can be operated under a mechanical torque transmitting state where the lock-up device 4 is engaged.

Downsizing the torus as foregoing may decline the torque transmission performance by the fluid. However, with the torque converter that transmits torque by the fluid only when vehicle starts and the lock-up device is engaged when a vehicle travels at equal to or faster than 20 km/h, the decline of the torque transmission performance by the fluid does not cause a lot of problems.

### (2) Operation

An operation of the torque converter 1 will be explained as follows. A torque transmitted from a crankshaft at an engine side is inputted into the front cover 2 via a flexible plate. By the torque inputted to the front cover, the impeller 10 rotates so that the working fluid flows from the impeller 10 to the turbine 11. By the flow of the working fluid, the turbine 11 rotates, and the torque of the turbine 11 is outputted to the main driveshaft 71.

When a speed ratio of the torque converter 1 increases and the main driveshaft 71 rotates at a predetermined rotation speed, the working fluid in the front chamber 81 drains from the first port 66. Consequently, the piston 41 moves towards the front cover 2. Accordingly, the friction facing 46 is pushed to the friction surface 70 of the front cover 2 and the torque of the front cover 2 is outputted to the lock-up device 4. In the lock-up device 4, a torque is transmitted in sequence through the piston 41, the drive member 50, the torsion spring 52 and driven member 51, to the turbine hub 23.

### (3) Effect of the Invention

Effects of the embodiment of the present invention will be explained as follows. According to the torque converter 1, a structure of the damper mechanism is simplified by positioning the damper mechanism 42 of the lock-up device 4 radially inward compared to the working fluid chamber 3. Particularly, the number of the parts of the present invention is reduced compared to a known structure in which a torsion spring is sandwiched by two plates and a hub flange provided between the plates is fixed to a turbine hub with rivets.

Particularly, since the driven member 51 of the damper mechanism 42 is fixed to the inner periphery portion 20a of the turbine shell 20, in other words, since the damper mechanism 42 is positioned within the recess portion of the turbine shell 20, an axial dimension of the inner periphery portion of the torque converter 1 can be formed adequately small.

Since the end of the torsion spring 52 at the engine side in the axial direction and the end of the drive member 50 at the engine side in the axial direction are positioned close to the transmission compared to the portion of the turbine shell 20 of the turbine 11 which is closest to the engine in the axial direction, the axial dimension of the inner periphery portion of the torque converter 1 can be adequately small.

### (4) Other Embodiments

The present invention is not limited to the construction of the foregoing embodiment and can be varied as long as not departing from the spirit and scope of the present invention.

The driven member may be constructed with plural members which are divided and arranged in a circumferential direction.

The driven member may be fixed to the turbine shell with rivets or by clinch.

### INDUSTRIAL APPLICABILITY

Since the present invention enables to simplify a structure of a lock-up device, the present invention is applicable to a torque converter, particularly to a torque converter which includes a lock-up device.

1. A torque converter, comprising:
a front cover;
an impeller being connected to the front cover to form a fluid chamber;
a turbine being arranged to face the impeller in the fluid chamber and including a turbine shell, a turbine blade being attached to an impeller side surface of the turbine shell, and a turbine hub being fixed to an inner periphery portion of the turbine shell;
a stator being arranged between an inner periphery portion of the impeller and an inner periphery portion of the turbine and forming a working fluid chamber together with the impeller and the turbine; and
a lock-up device being arranged between the front cover and the turbine and mechanically coupling the front cover and the turbine, the lock-up device including a torsion spring being configured to absorb and to damp a torsional vibration,
an outer periphery end of the torsion spring being positioned radially inward relative to an inner periphery end of the working fluid chamber, and
the lock-up device including
a piston being configured to connect to the front cover,
the torsion spring,
a drive member being fixed to the piston to drive the torsion spring, and
a driven member being fixed to the turbine shell to be driven by the torsion spring.

2. The torque converter according to claim 1, wherein the driven member is fixed to a fixing portion that is positioned radially inward relative to a portion of the turbine shell to which the turbine blade is attached.

3. The torque converter according to claim 2, wherein the stator includes an annular stator carrier and a stator blade that is provided at an outer periphery surface of the stator carrier, and
the stator carrier includes a recess portion formed on a torsion spring side surface at a position corresponding to the torsion spring.

4. The torque converter according to claim 3, wherein the fixing portion of the turbine shell is configured to have a shape along the recess portion and arranged close to the recess portion.

5. The torque converter according to claim 4, wherein the fixing portion of the turbine shell is positioned close to a center position of the impeller and the turbine in an axial direction.

6. The torque converter according to claim 5, wherein the fixing portion of the turbine shell is positioned closer to the impeller relative to the center position of the impeller and the turbine in the axial direction.

7. The torque converter according to claim 6, wherein the fixing portion of the turbine shell includes a plane surface that is vertical to a rotational axis.

8. The torque converter according to claim 7, wherein the driven member is annularly arranged corresponding to the torsion spring.

9. The torque converter according to claim 8, wherein the driven member includes a plurality of claws that extends towards the piston and the claws are in contact with ends of the torsion spring in a rotational direction.

10. The torque converter according to claim 9, wherein an end of the torsion spring at an engine side in an axial direction is positioned closer to the transmission in the axial direction relative to a most engine side end of the turbine shell.

11. The torque converter according to claim 2, wherein the fixing portion of the turbine shell includes a plane surface that is vertical to a rotational axis.

12. The torque converter according to claim 11, wherein the driven member is annularly arranged corresponding to the torsion spring.

13. The torque converter according to claim 12, wherein the driven member includes a plurality of claws that extends towards the piston and the claws are in contact with ends of the torsion spring in a rotational direction.

14. The torque converter according to claim 13, wherein an end of the torsion spring at an engine side in an axial direction is positioned closer to the transmission in the axial direction relative to a most engine side end of the turbine shell.

15. The torque converter according to claim 1, wherein the driven member is annularly arranged corresponding to the torsion spring.

16. The torque converter according to claim 15, wherein the driven member includes a plurality of claws that extends towards the piston and the claws are in contact with ends of the torsion spring in a rotational direction.

17. The torque converter according to claim 16, wherein an end of the torsion spring at an engine side in an axial direction is positioned closer to the transmission in the axial direction relative to a most engine side end of the turbine shell.

18. The torque converter according to claim 1, wherein the driven member includes a plurality of claws that extends towards the piston and the claws are in contact with ends of the torsion spring in a rotational direction.

19. The torque converter according to claim 18, wherein an end of the torsion spring at an engine side in an axial direction is positioned closer to the transmission in the axial direction relative to a most engine side end of the turbine shell.

20. The torque converter according to claim 1, wherein an end of the torsion spring at an engine side in an axial direction is positioned closer to the transmission in the axial direction relative to a most engine side end of the turbine shell.
